(19) United States
(12) Patent Application Publication
(10) Pub. No.: US 2006/0115271 A1
(43) Pub. Date: Jun. 1, 2006

(54) Method for operating wavelength-division-multiplexed passive optical network

(75) Inventors: Seong-Taek Hwang, Pyeongtaek-si (KR); Yun-Je Oh, Yongin-si (KR); Dae-Kwang Jung, Suwon-si (KR); Jin-Woo Park, Seoul (KR); Sung-Kuen Lee, Seoul (KR); Yong-Won Lee, Bucheon-si (KR); Sang-Rok Lee, Seoul (KR); Sang-Mo Hong, Goyang-si (KR)

Correspondence Address: CHA & REITER, LLC, 210 ROUTE 4 EAST STE 103, PARAMUS, NJ, 07652, US

(73) Assignee: Samsung Electronics Co., LTD.

(21) Appl. No.: 11/058,793

(22) Filed: Feb. 16, 2005

(30) Foreign Application Priority Data
Nov. 29, 2004 (KR) 2004-98663

(51) Int. Cl. H04J 14/00

(52) U.S. Cl. 398/72

(57) ABSTRACT

Disclosed is a method for operating a wavelength-division-multiplexed passive optical network (WDM-PON) including an optical line terminal (OLT) and a plurality of optical network units (ONUs), each of which is connected to the OLT and communicates with the OLT. The method comprises the steps of transmitting a first control channel including allocation information of downstream data channels and allocation information of time slots for the downstream data channels to each of the plurality of ONUs; and transmitting downstream data to the plurality of ONUs using their associated downstream data channels, each having at least one time slot, based on the information included in the first control channel.

### CLAIM of PRIORITY

This application claims benefit, under 35 U.S.C. § 119, to the earlier filing date of that patent application entitled “Method for Operating Wavelength-Division-Multiplexed Passive Optical Network,” filed in the Korean Intellectual Property Office on Nov. 29, 2004 and assigned Serial No. 2004-98663, the contents of which are incorporated herein by reference.

### BACKGROUND OF THE INVENTION

1. Field of the Invention

The present invention relates to a wavelength-division-multiplexed passive optical network (WDM-PON), and in particular, to an operating method for allocating, by an optical line terminal (OLT), bandwidths to optical network units (ONUs) in the WDM-PON having a passive optical power distributor.

2. Description of the Related Art

Recently, in order to accommodate the rapid increase of Internet demands and to efficiently and economically provide various multimedia services based on broadband signal transmission, optical subscriber network technology is being deployed for increasing communication bands and improving transmission quality, while Fiber To The x (FTTx) technology is being used for guaranteeing a data rate up to several Gigabits per second (Gbps).

The PON (Passive Optical Network) is a scheme for providing broadband services to subscribers at a very high rate of several tens of Megabits per second (Mbps), using optical cable, and a point-to-multipoint topology in which one OLT is connected to a plurality of ONUs using a passive optical power distributor. Accordingly, local communication providers have been interested in the PON scheme or method for a long time as the PON method requires less optical line construction expenses than other network schemes and power supply problems are of little or no concern due to the use of the passive optical power distributor.

The core of the PON scheme is development of a system providing more bandwidths with less expense, and the structure of the PON suggested in the early stage of development was as a time-division-multiplexing PON (TDM-PON). Examples of TDM-PON are asynchronous transfer mode PON (ATM-PON) and an Ethernet PON (E-PON). The ATM-PON, which was suggested and approved by the International Telecommunication Union-Telecommunication Standardization Sector (ITU-T) typically is used to satisfy full services access network (FSAN) requirements. The E-PON, which has been being standardized by the Institute of Electrical and Electronics Engineers (IEEE) 802.3ah Task Force, is typically a single wavelength channel used for transmission/reception that is split into time bands. Another PON is a Wavelength Division Multiplexed PON (WDM-PON) which utilizes a WDM technology, wherein as many wavelength channels as the number of ONUs connected to a PON are used, has been suggested.

Since a conventional TDM-PON has a structure in which a plurality of subscribers share one wavelength channel, each subscriber can use only a time band obtained by equally splitting the time band of the one wavelength channel by the number of subscribers. Because the conventional TDM-PON uses a passive optical power distributor, the output power of an OLT is split by the number of subscribers and transferred to each subscriber. Accordingly, when a PON is designed, it is necessary to pay careful attention to power budget calculations. Furthermore, as signals to other subscribers are transmitted to each subscriber, it is necessary for an upper network layer to take the responsibility for security, and since one ONU must operate at a speed proportional to the number of subscribers connected together, there is another disadvantage that a complicated media access control (MAC) protocol is necessary.

The WDM-PON. on the other hand, allocates one dedicated wavelength channel to each subscriber, in principle, by using a passive wavelength router, such as an arrayed waveguide grating (AWG), between an OLT and ONUs and has advantages that its transmission capacity is extended compared to the TDM-PON and security and MAC requirements do not have to be considered. Furthermore, the burden of determining a power budget is dramatically relieved. However, since the number of subscribers depends on the number of wavelengths in this basic WDM-PON, there is a disadvantage in that the number of subscribers is limited. Furthermore, as a multimedia service requires a wide bandwidth, one wavelength channel having transmission capability of more than hundreds of Gbps allocated to each subscriber in a current service level is not possible. Such, allocation of one wavelength channel to each subscriber is also a waste of wavelength resources. Currently, the number of wavelengths that can be used for the WDM technology is limited, and the expensive light sources used are a further obstacle to realization of the WDM-PON. In summary, the WDM-PON has disadvantages as there may be a significant waste of bandwidths, a barrier in the number of wavelength channels and, hence, the number of subscribers, and a high transceiver cost.

Hence, there is a need in the industry for a method and system for providing efficient utilization of bandwidths (wavelength and/or time) to accommodate the bandwidth requirements of each subscriber having access to the network.

### SUMMARY OF THE INVENTION

Accordingly, an object of the present invention is to provide a PON operating method for preventing bandwidths from being wasted by efficiently using limited bandwidths (wavelength bandwidths and time bandwidths) and accommodating services demanded by the subscribers in a wavelength-division-multiplexed passive optical network (WDM-PON) including an optical line terminal (OLT), a plurality of optical network units (ONUs), and a passive optical power distributor connecting the OLT and the ONUs to each other using a point-to-multipoint topology.

According to one aspect of the present invention, there is provided a method for operating a WDM-PON including an optical line terminal (OLT) and a plurality of optical network units (ONUs), each of which is connected to and communicates with the OLT. The method comprises the steps of transmitting a first control channel including allocation information of downstream data channels and allocation information of time slots for the downstream data channels to each of the plurality of ONUs; and transmitting downstream data to the plurality of ONUs using their associated downstream data channels, each having at least one time slot, based on the information included in the first control channel.

According to another aspect of the present invention, there is provided a method for operating a WDM-PON including an OLT and a plurality of ONUs, each of which is connected to the OLT and communicates with the OLT. The method comprises the steps of receiving a second control channel including information on service levels of upstream data from each of the plurality of ONUs; and transmitting a first control channel including allocation information of upstream data channels and allocation information of time slots for the upstream data channels to each of the plurality of ONUs.

### BRIEF DESCRIPTION OF THE DRAWINGS

The above features and advantages of the present invention will become more apparent from the following detailed description when taken in conjunction with the accompanying drawings in which:

FIG. 1 illustrates a WDM-PON according to a preferred embodiment of the present invention;

FIG. 2 illustrates an exemplary format of a first control channel in accordance with the principles of the invention;

FIGS. 3A to 3C illustrate an example of downstream data transmission in the WDM-PON shown in FIG. 1;

FIGS. 4A to 4C illustrate a second example of downstream data transmission in the WDM-PON shown in FIG. 1;

FIG. 5 illustrates an exemplary format of a second control channel in accordance with the principles of the invention;

FIGS. 6A and 6B illustrate an example of upstream data transmission in the WDM-PON shown in FIG. 1;

FIG. 7 is an exemplary block diagram of an OLT shown in FIG. 1;

FIG. 8 is an exemplary block diagram of a P^{th} ONU;

FIG. 9 is a flowchart illustrating an initial registering process in the WDM-PON shown in FIG. 1;

FIG. 10 is a flowchart illustrating an additional bandwidth allocating process in the WDM-PON shown in FIG. 1; and

FIG. 11 is a flowchart illustrating a bandwidth changing process in the WDM-PON shown in FIG. 1.

### DETAILED DESCRIPTION

A preferred embodiment of the present invention will be described with reference to the accompanying drawings. In the following description, well-known functions or constructions are not described in detail as they obscure the invention in unnecessary detail.

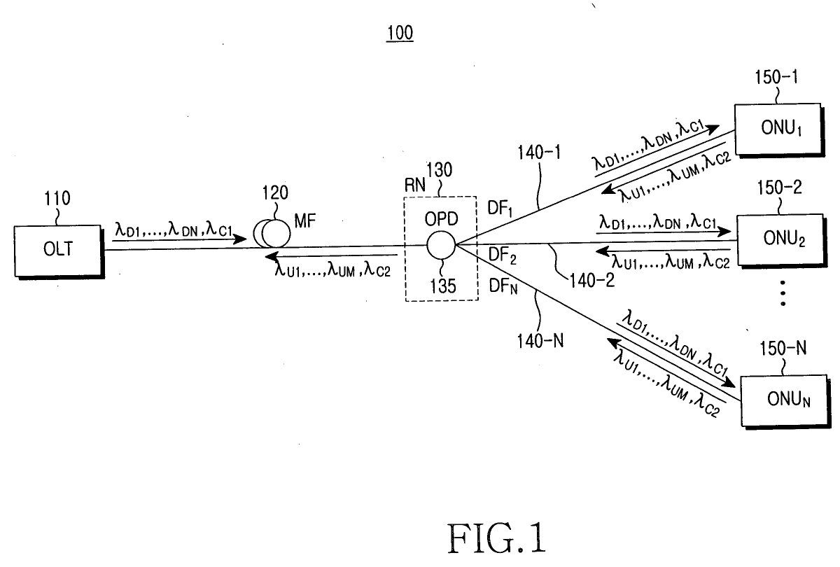

FIG. 1 illustrates a wavelength-division-multiplexed passive optical network (WDM-PON) 100 according to a preferred embodiment of the present invention. Referring to FIG. 1, the WDM-PON 100 includes an optical line terminal (OLT) 110, a remote node (RN) 130, which is connected to the OLT 110 via a main optical fiber (MF) 120, and first through N^{th} optical network units (ONUs) 150-1 through 150-N, which are connected to the RN 130 via first through N^{th} distribution optical fibers (DFs) 140-1 through 140-N. The first through N^{th} ONUs 150-1 through 150-N are connected to the OLT 110 via the RN 130 on a point-to-multipoint basis. The OLT 110 downstream-transmits downstream data and control information using first through N^{th} downstream data channels λ_{D1} through λ_{DN}, each of an independent wavelength, and a first control channel λ_{C1}. The RN 130 includes an optical power distributor (OPD) 135, which power-splits, substantially equally, each of the first through N^{th} downstream data channels λ_{D1} through λ_{DN} and the first control channel λ_{C1} received from the OLT 110 into N sub-channels, and distributes the power-split first through N^{th} downstream data channels λ_{D1} through λ_{DN} and the power-split first control channel λ_{C1} to the first through N^{th} ONUs 150-1 through 150-N. Each of the first through N^{th} ONUs 150-1 through 150-N upstream-transmits upstream data and queue information using first through M^{th} upstream data channels λ_{U1} through λ_{UM} and a second control channel λ_{C2}, and the OPD 135 combines the first through M^{th} upstream data channels λ_{U1} through λ_{UM} and the second control channel λ_{C2} received from the first through N^{th} ONUs 150-1 through 150-N and transmits the combined channels to the OLT 110.

The downstream transmission and the upstream transmission in the WDM-PON 100 will now be described.

The downstream transmission in the WDM-PON 100 includes following operating procedures (a) through (c).

(a) When the OLT 110 receives downstream data targeting the first through N^{th} ONUs 150-1 through 150-N from a connected external backbone network (not shown), the OLT 110 derives a service level determined by a quality-of-service (QoS) level and a length of each of the downstream data. The OLT 110 determines kind and the number (wavelength information) of the downstream data channels to be allocated to their associated ONUs and start times and lengths (time information) of time slots to be allocated to each allocated downstream data channel according to the derived service levels, using a pre-set bandwidth allocation algorithm.

(b) The OLT 110 downstream-transmits control information including the wavelength information (that is, downstream data channel allocation information) and time information (that is, time slot allocation information) determined in the procedure (a) to the first through N^{th} ONUs 150-1 through 150-N using the first control channel λ_{C1}. Each of the first through N^{th} ONUs 150-1 through 150-N selectively receives a first control frame loaded in a time slot pre-allocated thereto from the first control channel λ_{C1}. Each of the first through N^{th} ONUs 150-1 through 150-N recognizes the wavelength information and time information of the received first control frame and then prepares to receive a downstream data frame loaded in the allocated time slot of the allocated downstream data channel.

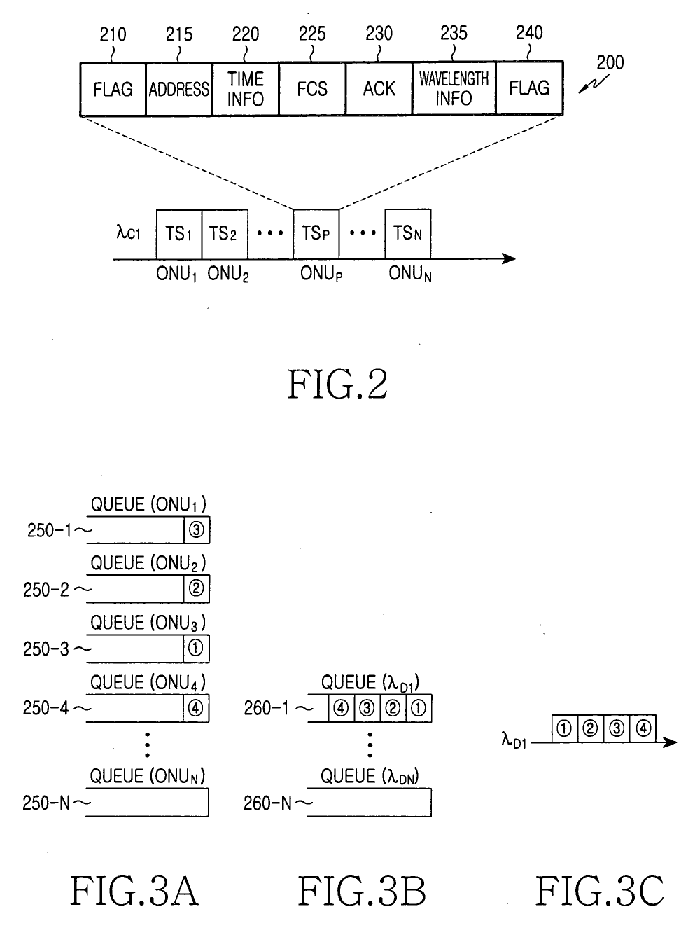

FIG. 2 illustrates an exemplary format of first control channel λ_{C1}. Referring to FIG. 2, the first control channel λ_{C1} includes first through N^{th} time slots TS₁ through. TS_{N} making one cycle, wherein a P^{th} time slot TS_{P} is allocated to a P^{th} ONU 150-P. A first control frame 200 loaded in each time slot, wherein the first control frame in the P^{th} time slot TS_{P} is shown in detail. The first control frame includes wavelength information 235 and time information 220 of the P^{th} ONU 150-P. Specifically, the first control frame 200 includes first and second flags 210 and 240, an address 215, the time information 220, a frame check sequence (FCS) 225, an acknowledgement (ACK) 230, and the wavelength information 235. The first and second flags 210 and 240 are used for acquiring synchronization and indicating a start or an end of the first control frame 200. The address 215 indicates a destination address (DA) or a source address (SA). The FCS 225 provides for error checking of a bitstream (except the first and second flags 210 and 240 and the ACK 230), and the ACK 230 displays NAK (Negative Acknowledgement) in the presence of a transmission error and ACK in the absence of a transmission error. The wavelength information 235 includes kind and the number of allocated downstream data channels, and the time information 220 includes start times and lengths of time slots allocated to each allocated downstream data channel.

(c) The OLT 110 transmits downstream data to the first through N^{th} ONUs 150-1 through 150-N using their associated downstream data channels each having at least one time slot based on control information of the first control channel λ_{C1}.

FIGS. 3A to 3C illustrate an example of the downstream data transmission in the WDM-PON 100 during low traffic periods. Referring to FIGS. 3A to 3C, the OLT 110 includes first through N^{th} ONU queues 250-1 through 250-N, and a P^{th} ONU queue 250-P is allocated to the P^{th} ONU 150-P. The first through fourth ONU queues 250-1 through 250-4 shown in FIG. 3A store their associated downstream data frames (1) through (4). Further, the OLT 110 includes first through N^{th} data channel queues 260-1 through 260-N, wherein a P^{th} data channel queue 260-P is allocated to a P^{th} downstream data channel. The first through fourth downstream data frames (1) through (4), which are stored in the first through fourth ONU queues 250-1 through 250-4, are transferred to the first data channel queue 260-1 shown in FIG. 3B on the basis of their service levels. Also, the bandwidth allocation algorithm can be applied such that the first through fourth downstream data frames (1) through (4) are transferred to the first data channel queue 260-1 in the order of heir reception. FIG. 3C shows the downstream data transmission using the downstream data channel λ_{D1}, and the OLT 110 adds addresses (ONU numbers) and frame lengths to each of the first through fourth downstream data frames (1) through (4) before transmission. (not shown). As described above, the OLT 110 downstream-transmits control information to the first through N^{th} ONUs 150-1 through 150-N using the first control channel λ_{C1} in advance of the downstream data transmission.

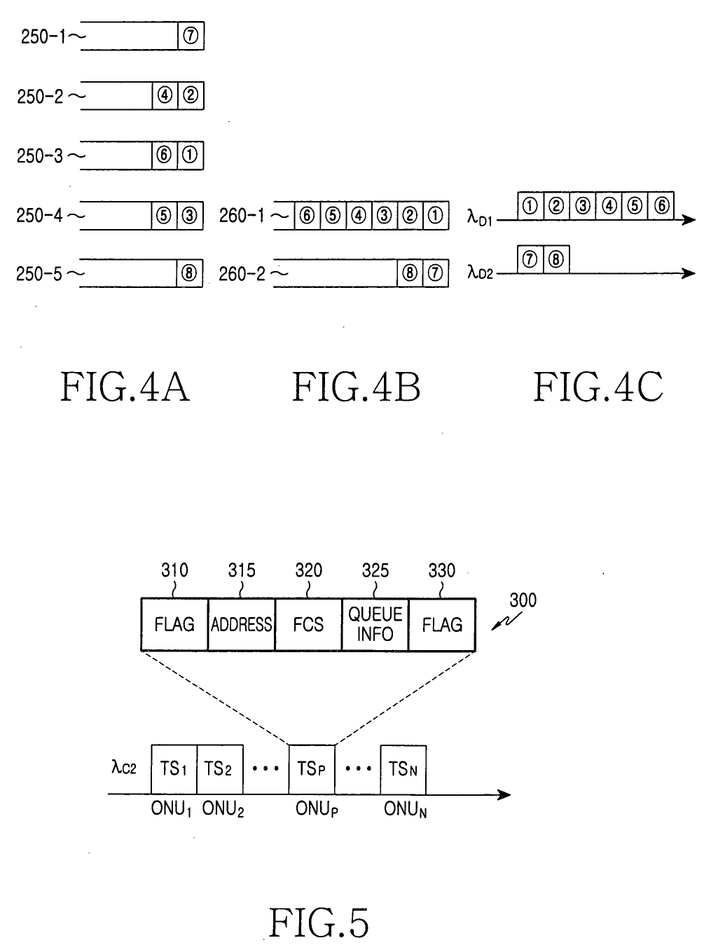

FIGS. 4A to 4C illustrate another example of the downstream data transmission in the WDM-PON 100 during high traffic periods. Referring to FIGS. 4A to 4C, the first through fifth ONU queues 250-1 through 250-5 are shown in FIG. 4A and also shown are their associated downstream data frames (1) through (8). The first and second data channel queues 260-1 and 260-2 are shown in FIG. 4B. First through sixth downstream data frames (1) through (6), stored in the second through fourth ONU queues 250-2 through 250-4, are transferred to the first data channel queue 260-1 on the basis of their service levels, and the seventh and eighth downstream data frames (7) and (8), stored in the first and fifth ONU queues 250-1 and 250-5, are transferred to the second data channel queue 260-2 on the basis of their service levels. Also, a bandwidth allocation algorithm can be applied such that the downstream data frames are first transferred to the first data channel queue 260-1 in the order of their reception, and when the maximum queue capacity of the first data channel queue 260-1 is exceeded, the remaining downstream data frames are transferred to the second data channel queue 260-2 in the order of their reception. In another aspect, the bandwidth allocation algorithm can be applied such that the downstream data frames are first transferred to the first data channel queue 260-1 in the order of their reception, and downstream data frames, each having a longer length than a predetermined length, are transferred to the second data channel queue 260-2 in the order of their reception. In this manner, usage efficiency of the first and second data channel queues, 260-1, 260-2, respectively, is improved. Also, when the number of downstream data frames stored in the first data channel queue 260-1 is less than a threshold, the bandwidth allocation algorithm can be applied so that only the first data channel queue 260-1 is used, and in this case, marginal queue capacity of the second data channel queue 260-2 can be maintained. FIG. 4C shows the downstream data transmission using the first and second downstream data channels λ_{D1} and λ_{D2}, and the OLT 110 adds addresses (ONU numbers) and frame lengths to the respective downstream data frames, before transmission (not shown).

The upstream transmission in the WDM-PON 100 includes following procedures (a) through (e).

(a) Each of the first through N^{th} ONUs 150-1 through 150-N upstream-transmits its own queue information to the OLT 110 using the second control channel λ_{C2}. The queue information includes service level information (determined by a QoS level and a length) of upstream transmission data.

FIG. 5 illustrates an exemplary format of second control channel λ_{C2}. Referring to FIG. 5, the second control channel λ_{C2} includes first through N^{th} time slots TS₁ through TS_{N} making one cycle, wherein a P^{th} time slot TS_{P} is allocated to a P^{th} ONU 150-P. A second control frame 300, which is shown in detail with regard to the P^{th} time slot, is loaded in the P^{th} time slot TS_{P} includes queue information 325 of the P^{th} ONU 150-P. Specifically, the second control frame 300 includes first and second flags 310 and 330, an address 315, an FCS 320, and the queue information 325. Also, the second control frame 300 can further include an ACK.

(b) When the OLT 110 receives queue information from the first through Nth ONUs 150-1 through 150-N, the OLT 110 determines control information to be provided to each of the first through N^{th} ONUs 150-1 through 150-N based on a service level (determined by a QoS level and a length) of each upstream transmission data. The OLT 110 determines wavelength information (kind and the number of upstream data channels to be allocated) and time information (start times and length of time slots of each upstream data channel to be allocated) of each of the first through N^{th} ONUs 150-1 through 150-N based on their service levels using the bandwidth allocation algorithm.

(c) The OLT 110 downstream-transmits the control information including the wavelength information and time information determined in the procedure (b) to the first through N^{th} ONUs 150-1 through 150-N using the first control channel λ_{C1}.

(d) Each of the first through N^{th} ONUs 150-1 through 150-N selectively receives a first control frame loaded in a time slot allocated thereto from the input first control channel λ_{C1}. Each of the first through N^{th} ONUs 150-1 through 150-N recognizes the wavelength information and time information of the received first control frame.

(e) Each of the first through N^{th} ONUs 150-1 through 150-N transmits its upstream data frames to the OLT 110 using upstream data channels, each having time slots allocated on the basis of the control information of the input first control channel λ_{C1}.

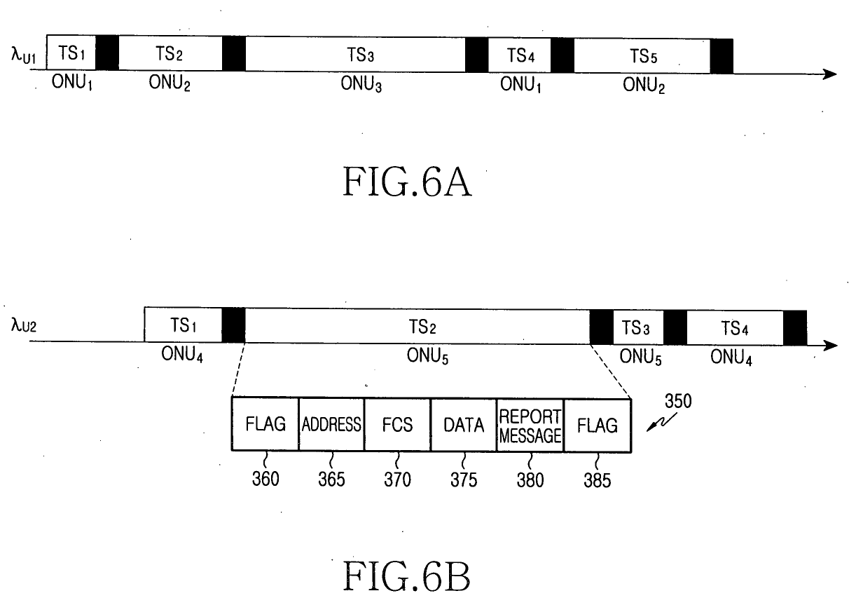

FIGS. 6A and 6B illustrate an example of the upstream data transmission in the WDM-PON 100. Specifically, FIG. 6A illustrates the first upstream data channel λ_{U1}, and FIG. 6B illustrates the second upstream data channel λ_{U2}. The first upstream data channel λ_{U1} includes first through fifth time slots TS₁ through TS₅, wherein an upstream data frame of the first ONU 150-1 is loaded in the first time slot TS₁, an upstream data frame of the second ONU 150-2 is loaded in the second time slot TS₂, an upstream data frame of the third ONU 150-3 is loaded in the third time slot TS₃, another upstream data frame of the first ONU 150-1 is loaded in the fourth time slot TS₄, and another upstream data frame of the second ONU 150-2 is loaded in the fifth time slot TS₅. The second upstream data channel λ_{U2} includes first through fourth time slots TS₁ through TS₄, wherein an upstream data frame of the fourth ONU 150-4 is loaded in the first time slot TS₁, an upstream data frame of the fifth ONU 150-5 is loaded in the second time slot TS₂, another upstream data frame of the fifth ONU 150-5 is loaded in the third time slot TS₃, and another upstream data frame of the fourth ONU 150-4 is loaded in the fourth time slot TS₄. Each of the upstream data frames includes first and second flags 360 and 385, an address 365, an FCS 370, data 375, and a report message 380, as shown in more detail in FIG. 6B. The report message 380 may include queue information (a QoS level and length of upstream data) and an ACK of data to be transmitted from its associated ONU. In a case where queue information is transmitted to the OLT 110 using report messages, the second control channel λ_{C2} may not be used. That is, each of the first through N^{th} ONUs 150-1 through 150-N can upstream-transmit its own queue information to the OLT 110 using report messages of upstream data frames loaded in its associated upstream data channel.

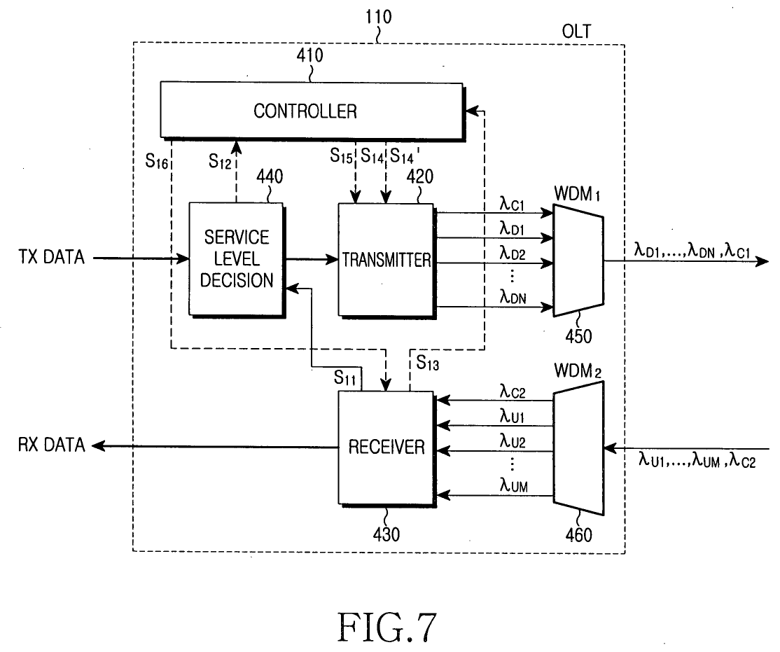

FIG. 7 illustrates a block diagram of the OLT 110 shown in FIG. 1. Referring to FIG. 7, the OLT 110 includes a controller 410, a transmitter 420, a receiver 430, a service level decision unit 440, and first and second wavelength division multiplexers (WDM) 450 and 460. Although the elements are shown as discreet components it would be recognized that some or all of the elements shown may be contained in an integrated processing component.

The service level decision unit 440 receives downstream data frames from a connected external backbone network (not shown) and a second control frame S₁₁ from the receiver 430. The service level decision unit 440 outputs a service level signal S₁₂ determined by QoS levels and lengths of data included in the received downstream data frames to the controller 410. The service level decision unit 440 outputs the downstream data frames, whose service levels are determined, to the transmitter 420.

The controller 410 has a bandwidth allocation algorithm for dynamically allocating bandwidths and receives the service level signal S₁₂ and queue information S₁₃. The controller 410 determines kind and the number (wavelength information) of downstream data channels to be allocated to the associated ONUs and start times and length (time information) of time slots to be allocated to the allocated downstream data channels on the basis of service levels indicated by the service level signal S₁₂ using the bandwidth allocation algorithm and outputs a first control frame S₁₄ including the control information (the wavelength information and time information) to the transmitter 420. Also, the controller 410 determines kind and the number (wavelength information) of upstream data channels to be allocated to the associated ONUs and start times and lengths (time information) of time slots to be allocated to the allocated downstream data channels on the basis of service levels indicated by the queue information S₁₃ using the bandwidth allocation algorithm and outputs a first control frame S₁₄′ including the control information (the wavelength information and time information) to the transmitter 420. The controller 410 deploys downstream data frames stored in first and N^{th} ONU queues of the transmitter 420 to their associated data channel queues on the basis of the wavelength information and time information of the first control frame S₁₄ and outputs a first control signal S₁₅ for transmitting the downstream data frames at the associated slot times to the transmitter 420.

The transmitter 420 receives the first control frames S₁₄ and S₁₄′ from the controller 410 and the downstream data frames from the service level decision unit 440. The transmitter 420 downstream-transmits the first control frames S₁₄ and S₁₄′ using a first control channel. Also, the transmitter 420 downstream-transmits the downstream data frames using their associated downstream data channels on the basis of the first control signal S₁₅ input from the controller 410. As would be recognizsed in the art, the transmitter 420 may include a laser diode (LD) array or a wavelength tunable LD the output of which is used for the transmission carrier wavelength.

The first WDM 450 wavelength-division-multiplexes the downstream data channels and first control channel input from the transmitter 420 and transmits the wavelength-division-multiplexed downstream data channels and first control channel via a main optical fiber (MF). (see FIG. 1). The second WDM 460 demultiplexes upstream data channels and a second control channel received from the MF.

The receiver 430 photoelectrically converts the upstream data channels and the second control channel input from the second WDM 460 and outputs the queue information S₁₃ of upstream data frames and the second control frame. The queue information S₁₃ is input to the controller 410. The receiver 430 may include an optical filter array or a wavelength tunable optical filter.

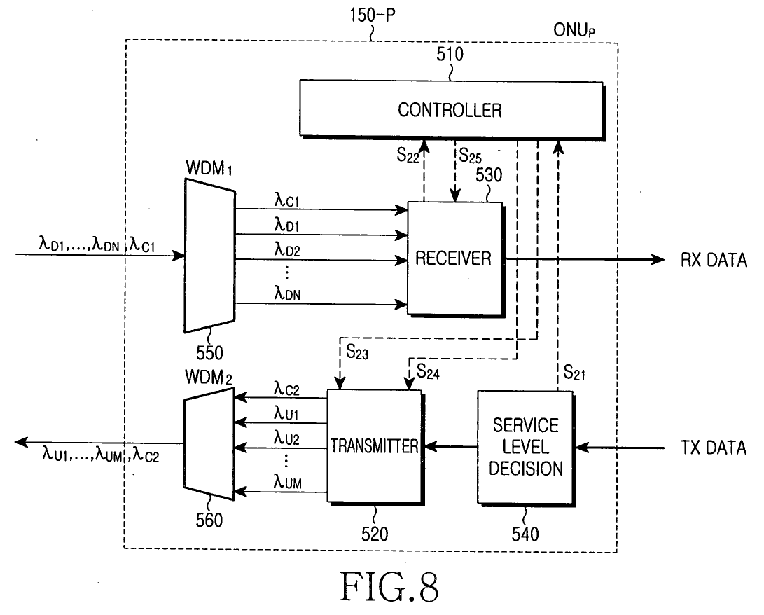

FIG. 8 illustrates a block diagram of the P^{th} ONU 150-P. Referring to FIG. 8, the P^{th} ONU 150-P includes a controller 510, a transmitter 520, a receiver 530, a service level decision unit 540, and first and second WDMs 550 and 560.

The service level decision unit 540 receives upstream data frames from a connected subscriber, referred to as TX DATA. The service level decision unit 540 outputs a service level signal S₂₁ determined by QoS levels and length of data included in the received upstream data frames to the controller 510. The service level decision unit 540 outputs the upstream data frames, whose service levels are determined, to the transmitter 520.

The controller 510 receives the service level signal S₂₁ from service level decision unit 540 and control information S₂₂ from receiver 530. The controller 510 generates queue information from the service level signal S₂₁ input from the service level decision unit 540 and outputs a second control frame S₂₃ including the queue information to the transmitter 520. The queue information includes service levels (determined by the QoS levels and lengths) of data to be upstream-transmitted. The controller 510 transmits the second control frame S₂₃ stored in a control channel queue of the transmitter 520, deploys upstream data frames stored in first and M^{th} subscriber queues of the transmitter 520 to their associated data channel queues, and outputs a second control signal S₂₄ for transmitting the upstream data frames at their associated slot times to the transmitter 520. Also, the controller 510 outputs a first control signal S₂₅ for selectively receiving downstream data frames and a first control frame, which correspond to the P^{th} ONU 150-P, from downstream data channels and a first control channel, which are input to the receiver 530, on the basis of the control information S₂₂.

The transmitter 520 receives the second control frame S₂₃ from the controller 510 and the upstream data frames from the service level decision unit 540. The transmitter 520 upstream-transmits the second control frame S₂₃ using a second control channel on the basis of the second control signal S₂₄. Also, the transmitter 520 upstream-transmits the upstream data frames using their associated upstream data channels on the basis of the second control signal S₂₄ input from the controller 510. The transmitter 520 may include a laser diode (LD) array or a wavelength tunable LD. However, in a case where light for transmission is provided from the OLT to the transmitter 520, the transmitter 520 may include a reflective semiconductor optical amplifier (RSOA) or Fabry-Perot LD for modulating the light for transmission, and in a case where the WDM-PON 100 has a transmission/reception structure of a loop-back scheme, the transmitter 520 does not have to include a light source.

The second WDM 560 wavelength-division-multiplexes the upstream data channels and second control channel input from the transmitter 520 and transmits the wavelength-division-multiplexed downstream data channels and first control channel via the main optical fiber (MF).

The first WDM 550 demultiplexes the downstream data channels and first control channel, which are received via the MF.

The receiver 530 selectively photoelectric-converts frames of time slots corresponding to the P^{th} ONU 150-P from the downstream data channels and second control channel input from the first WDM 550 on the basis of the first control signal. The control information S₂₂ of the received first control frame is input to the controller 510. The receiver 530 may include an optical filter array or a wavelength tunable optical filter.

The above description will now be schematically summarized. Selection of downstream data channels used for downstream data transmission in the OLT is made by selecting available downstream data channels among first through N^{th} downstream data channels on the basis of QoS levels and length of data to be transmitted from the OLT 110 to specific ONUs, and the number of usable downstream data channels is determined by allocating at least one downstream data channel for the downstream data transmission on the basis of a length of data to be transmitted. Also, the number and length of time slots constituting one downstream data channel can be controlled according to the amount of the data to be transmitted. In a case where a service level is changed during the downstream data transmission, necessity of changing a downstream data channel and time slots may be generated, and in this case, a demanded service level of a subscriber can be adaptively dealt with by changing the length of the downstream data channel and time slots on the basis of control information transmitted from the OLT 110 to the first through N^{th} ONUs 150-1 through 150-N.

In upstream data transmission, collision between data transmitted from ONUs to the OLT 110 may occur, and required length of time slots may be changed according to a length of upstream data. Therefore, each of the first through N^{th} ONUs 150-1 through 150-N transmits queue information including QoS levels and length of transmission data to the OLT 110, and the OLT 110 allocates kind, number of upstream data channels and time slots required for the upstream data transmission to each of the first through N^{th} ONUs 150-1 through 150-N using the bandwidth allocation algorithm, thereby enabling adaptive upstream data transmission.

The WDM-PON 100 can perform an initial registering process, an additional bandwidth allocating process, and a bandwidth changing process if necessary.

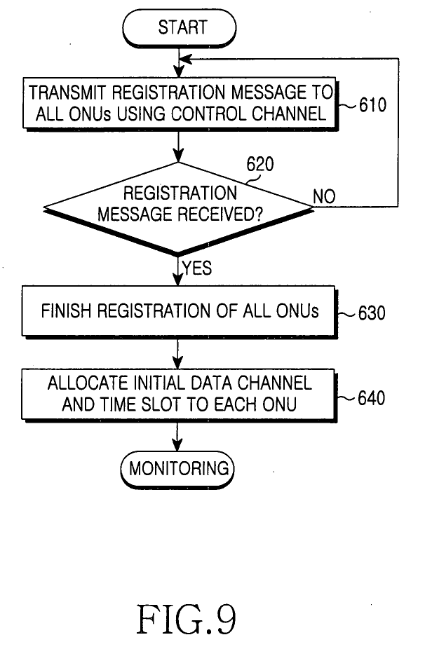

FIG. 9 is a flowchart illustrating the initial registering process in the WDM-PON 100. Referring to FIG. 9, the initial registering process is a process for registering all of the ONUs 150-1 through 150-N in the OLT 110. The initial registering process includes a register message transmitting step 610, a reception confirming step 620, a register finishing step 630, and an initial bandwidth allocating step 640.

In step 610, the OLT 110 periodically transmits a registration message to all the ONUs 150-1 through 150-N in the WDM-PON 100 using a first control channel.

In step 620, it is determined whether a registration request message is received from each of the ONUs 150-1 through 150-N. Until all registration request messages are received, step 610 is repeatedly performed.

In step 630, all of the ONUs 150-1 through 150-N are registered in the OLT 110 after the registration request messages are received from all the ONUs 150-1 through 150-N.

In step 640, a time slot of the first control channel, a time slot of a second control channel, upstream data channels and time slots for upstream data transmission, and downstream data channels and time slots for downstream data transmission are allocated to each of the ONUs 150-1 through 150-N.

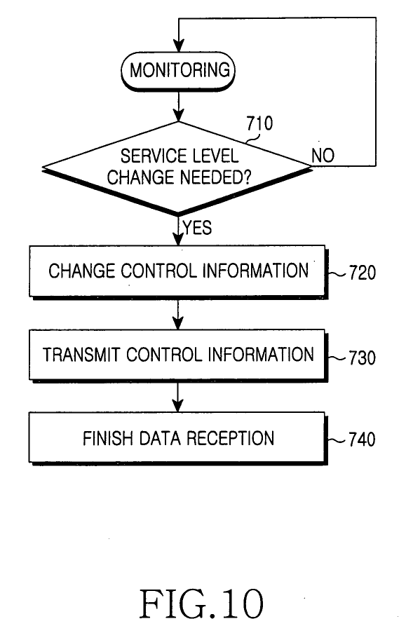

FIG. 10 is a flowchart illustrating the additional bandwidth allocating process in the WDM-PON 100. Referring to FIG. 10, the additional bandwidth allocating process is performed in response to a bandwidth change request (represented by a change in queue information) from an ONU and includes a service level change confirming step 710, a control information changing step 720, a control information transmitting step 730, and a data receiving step 740.

In step 710, the OLT 110 recognizes (performed by a bandwidth allocation algorithm) that it is necessary for control information to be changed in response to a change in the service level signal output from the service level decision unit 440 after receiving a second control channel. When a ONU needs to change a service level (determined by a QoS level and length) of upstream data to be transmitted, the ONU transmits queue information, which is generated by reflecting the service level, to the OLT 110 using a second control channel, and the bandwidth allocation algorithm of the OLT 110 recognizes that it is necessary for control information to be changed in response to the queue information.

In step 720, the bandwidth allocation algorithm of the OLT 110 changes wavelength information and time information based on the service level signal input from the service level decision unit 440.

In step 730, the OLT 110 transmits the changed control information to each of the ONUs 150-1 through 150-N using a first control channel.

In step 740, the OLT 110 receives data transmitted from the ONU on the basis of the control information.

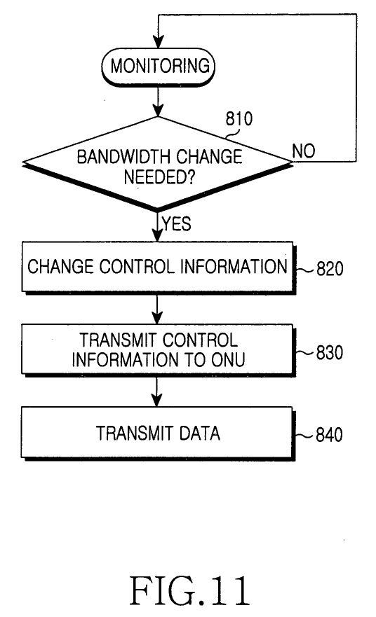

FIG. 11 is a flowchart illustrating the bandwidth changing process in the WDM-PON 100. Referring to FIG. 11, the bandwidth changing process is performed in a case where the OLT 110 receives data to be transmitted to each of the ONUs 150-1 through 150-N from an external backbone network and needs a change in bandwidth. The bandwidth changing process includes a service level change confirming step 810, a control information changing step 820, a control information transmitting step 830, and data transmitting step 840.

In step 810, the OLT 110 recognizes (performed by a bandwidth allocation algorithm) that it is necessary for control information to be changed in response to a change in the service level signal output from the service level decision unit 440 after receiving downstream data from the external backbone network.

In step 820, the bandwidth allocation algorithm of the OLT 110 changes wavelength information and time information based on the service level signal input from the service level decision unit 440.

In step 830, the OLT 110 transmits the changed control information to each of the ONUs 150-1 through 150-N using a first control channel.

In step 840, the OLT 110 transmits the downstream data to each of the ONUs 150-1 through 150-N on the basis of the control information.

As described above, in the embodiments of the present invention, an operating method of a WDM-PON has advantages in adaptively allocating bandwidths or in dynamically changing kind and number of wavelength channels and time slots used for data transmission on the basis of service levels required between an OLT and ONUs in the WDM-PON having a passive optical power distributor.

First, a WDM-PON having a passive optical power distributor according to the embodiments of the present invention can solve a limited-bandwidth problem of a TDM-PON due to an operation of a single wavelength by operating a plurality of wavelength channels. Therefore, the WDM-PON can be used as a progressive advancement structure, whose performance is improved from the TDM-PON.

Second, since a WDM-PON according to the embodiments of the present invention can satisfy demands of data traffic requested by an OLT and ONUs by using a plurality of wavelength channels, problems, such as economical inefficiency and a waste of wavelengths and bandwidths, of a conventional WDM-PON in which wavelength channels proportional to the number of ONUs are required can be solved.

Third, in a case where a dynamic bandwidth allocation algorithm of a WDM-PON according to the embodiments of the present invention is optimized, traffic demands of a subscriber network can be satisfied with the reduced number of wavelength channels, and economical efficiency can be obtained by reducing the required number of wavelengths, and more broadband optical subscribers can be accommodated.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for operating a WDM-PON including an optical line terminal (OLT) and a plurality of optical network units (ONUs), each of which is connected to the OLT and communicates with the OLT, the method comprising the steps of:
transmitting a first control channel including allocation information of downstream data channels and allocation information of time slots for the downstream data channels to each of the plurality of ONUs; and
transmitting downstream data to the plurality of ONUs using their associated downstream data channels, each having at least one time slot, based on the information included in the first control channel.

2. The method of claim 1, further comprising the step of:
deriving service levels of downstream data to be transmitted and determining kind and the number of downstream data channels to be allocated to their associated ONUs and start times and lengths of time slots to be allocated to each of the downstream data channels, on the basis of the service levels.

3. The method of claim 2, wherein the service levels are determined by QoS levels and lengths of the downstream data.

4. The method of claim 1, wherein the first control channel comprises a plurality of time slots allocated to each of the ONUs, and a control frame loaded in each of the time slots comprises allocation information of downstream data channels for the associated ONUs and allocation information of time slots of the downstream data channels.

5. The method of claim 1, wherein each of the ONUs selectively receives time slots allocated thereto from the first control channel.

6. A method for operating a WDM-PON including an OLT and a plurality of ONUs, each of which is connected to the OLT and communicates with the OLT, the method comprising the steps of:
receiving a second control channel including information on service levels of upstream data from each of the plurality of ONUs; and
transmitting a first control channel including allocation information of upstream data channels and allocation information of time slots for the upstream data channels to each of the plurality of ONUs.

7. The method of claim 6, further comprising the step of:
determining kind and the number of upstream data channels to be allocated to their associated ONUs and start times and lengths of time slots to be allocated to each of the upstream data channels, on the basis of the information received in the second control channel.

8. The method of claim 6, wherein the service levels are determined by QoS levels and lengths of the upstream data.

9. The method of claim 6, wherein the first control channel comprises a plurality of time slots allocated to each of the ONUs, and a control frame loaded in each of the time slots comprises allocation information of downstream data channels for the associated ONUs and allocation information of time slots of the downstream data channels.

10. The method of claim 6, wherein each of the ONUs selectively receives time slots allocated thereto from the input first control channel.

11. The method of claim 6, wherein each of the ONUs transmits its associated upstream data frames to the OLT using upstream data channels allocated thereto, each having time slots allocated thereto, on the basis of the information included in the first control channel.

12. An optical line terminal (OLT) in communication with a plurality of optical network units (ONUs), comprising:
service level decision unit for deriving service levels of downstream data to be transmitted;
a controller unit in communication with the service level decision unit for dynamically allocating channel and time slot information of the downstream data;
a transmitter in communication with the controller for transmitting a first control channel including the allocation channel and time slot information of downstream data channels to each of the plurality of ONUs; and
a multiplexer in communication with the transmitter for multiplexing the downstream data channels and the first control channel.

13. The OLT of claim 12, wherein the controller unit further determining kind and the number of downstream data channels to be allocated to their associated ONUs and start times and lengths of time slots to be allocated to each of the downstream data channels, on the basis of the service levels.

14. The OLT of claim 12, wherein the service levels are determined by QoS levels and lengths of the downstream data.

15. The OLT of claim 12, wherein the first control channel comprises a plurality of time slots allocated to each of the ONUs, and a control frame loaded in each of the time slots comprises allocation information of downstream data channels for the associated ONUs and allocation information of time slots of the downstream data channels.

16. The OLT of claim 12, wherein each of the ONUs selectively receives time slots allocated thereto from the first control channel.

17. The OLT of claim 12, further comprising:
a demultiplexer for demultiplexing the upstream data and a second control channel received from the ONUs; and
a receiver for providing the demultiplexed upstream data and the second control to the controller.

18. The OLT of claim 17, wherein the controller further
receiving the second control channel including information on service levels of upstream data from each of the plurality of ONUs;
determining allocation information of upstream data channels and allocation information of time slots for the upstream data; and
transmitting the first control channel including the allocation information the upstream data channels and allocation information of time slots for the upstream data channels to each of the plurality of ONUs.

19. The OLT of claim 17, wherein each of the ONUs transmits its associated upstream data frames to the OLT using upstream data channels allocated thereto, each having time slots allocated thereto, on the basis of the information included in the first control channel.

20. The OLT of claim 12 wherein each of the ONU's are dynamically registered.

21. The OLT of claim 12, wherein the bandwidths are dynamically allocated in response to a change in the service level.

22. The OLT of claim 12, wherein the bandwidths are changed in response to a change in the service level.
